(19) United States
(12) Patent Application Publication
(10) Pub. No.: US 2011/0262629 A1
(43) Pub. Date: Oct. 27, 2011

(54) METHOD FOR FABRICATING A NICKEL-CERMET ELECTRODE

(75) Inventors: Thibaud Delahaye, Saint Martin Le Vinoux (FR); Philippe Baclet, Is-Sur-Tille (FR)

(73) Assignee: COMMISSARIAT A L'ENERGIE ATOMIQUE ET AUX ENERGIES ALTERNATIVES, Paris (FR)

(21) Appl. No.: 13/142,177

(22) PCT Filed: Dec. 23, 2009
(86) PCT No.: PCT/EP2009/067826

§ 371 Date: Jun. 24, 2011

(30) Foreign Application Priority Data
Jan. 5, 2009 (FR) 0900015

(51) Int. Cl. B05D 5/12; C04B 35/48

(52) U.S. Cl. 427/115; 264/104

(57) ABSTRACT

The method for fabricating a nickel-cermet electrode comprises the steps of formation of a mixture comprising an organic nickel salt in solid state and at least one ceramic material in solid state at ambient temperature, followed by shaping of the mixture and heat treatment of the shaped mixture, preferably under reducing conditions, to form the nickel-cermet electrode. The organic nickel salt is chosen from a nickel acetate, a nickel carbonate and a nickel tartrate.

### BACKGROUND OF THE INVENTION

The invention relates to a method for fabricating a nickel-cermet electrode.

### STATE OF THE ART

Cermet is a composite material formed by ceramic and metal materials. Nickel-cermet is commonly used to form electrodes for solid oxide fuel cells (SOFC), protonic conductor fuel cells (PCFC) or solid oxide electrolysis cells (SOEC). In conventional manner, a nickel-cermet electrode is obtained from nickel and ceramic oxide powders by mechanical mixing and/or grinding. The mixture is then shaped, calcined at high temperature to form the composite and finally reduced in temperature to achieve the nickel-cermet electrode. The electric properties of the nickel-cermet electrode depend in critical manner on the microstructure, the distribution of the nickel and ceramic particles and the distribution of the open porosity.

For example purposes, the document US-A-2005/0095479 describes a method for fabricating a porous thin layer for an SOFC electrode. The method for forming a Ni—YSZ cermet comprises deposition of nickel or co-deposition with a Ni—YSZ ceramic on a YSZ substrate followed by annealing or sintering. Sintering or annealing in a reducing or oxidizing atmosphere is used to cause diffusion of the metal and to contribute to formation of the Ni-cermet pores.

Recent works have described fabrication methods of composite ceramic/NiO powder for SOFC electrodes enabling the shape, size and distribution of the particles forming the composite to be controlled.

In particular, the document U.S. Pat. No. 5,993,988 describes a fabrication method of composite nickel oxide NiO and stabilized zircon ceramic powder in cubic crystalline form with yttrium oxide (YSZ), from tetrahydrated nickel acetate Ni(CH₃COO)₂.4H₂O and a sol of YSZ. The formulation of the initial reactants gives an aqueous reactant solution that is then broken down thermally by spray pyrolysis. This first heat treatment gives an intermediate powder composed of particles of NiO and YSZ. When spray pyrolysis is performed, the initial aqueous reactant solution is sprayed and dried. During this step, the nickel acetate particles or the YSZ particles precipitate and agglomerate preferably according to their solubility in the aqueous solution. This selective precipitation enables a controlled distribution of the size of the NiO and YSZ particles to be obtained. The intermediate NiO/YSZ powder is then shaped and sintered to form the electrode.

Furthermore, in the article “Synthesis of NiO—YSZ composite particles for an electrode of solid oxide fuel cells by spray pyrolysis”, (Powder Technology, vol. 132, 2003, P. 52-56), Fukui et al. make an analysis of the mechanisms involved in decomposition of the initial Ni/YSZ acetate solution of the document U.S. Pat. No. 5,993,988 (summary), and in particular highlight the presence of an intermediate product formed by fine grains of Ni and YSZ acetate when pyrolysis is performed. This intermediate product is obtained at a temperature of more than 200° C.

The methods described above use powder nickel oxide, in agglomerated form or not. Nickel oxide NiO, classified as CMR i.e. carcinogenic, mutagenic and toxic for reproduction, is however a composite that presents a high toxicity in powder form. The use of such a composite as initial product or intermediate product requires complex and onerous precautions from the industrial standpoint as far as handling, storage and use are concerned.

Recent works have further described methods for fabricating nickel-cermet from nickel oxide precursors. These precursors directly give a NiO/YSZ composite where nickel oxide is trapped in the matrix formed by the YSZ ceramic, which is consequently inoffensive for human beings.

Notably, the document US-A-2003/0211381 describes a method for fabricating a nickel-cermet anode for an SOFC comprising formation of a porous layer constituted by a mixture of zircon fibers and zircon powder stabilized with yttrium oxide (YSZ), and impregnation of this porous layer by a nickel nitrate solution. The Ni nitrate is then transformed into nickel oxide by calcination to form the NiO/YSZ composite. A nickel-cermet is then obtained by in situ reduction of nickel oxide to metallic nickel.

The document U.S. Pat. No. 5,261,944 likewise discloses formation of a NiO/YSZ composite for formation of an anodic material of a fuel cell from precursor salts: zirconyl and yttrium nitrate for the YSZ precursor and nickel acetate for the NiO precursor. The zirconyl and yttrium salts and nickel acetate Ni(CH₃COO)₂ are dissolved in an aqueous solution of hydroxyacid, amino acid or poly(acrylic) acid. The water is then eliminated under conditions preventing any decomposition of the salts to give a porous friable solid. The latter is then calcined to a temperature comprised between 800° C. and 1000° C. to form the NiO/YSZ composite in the form of two distinct phases, nickel oxide and YSZ ceramic. The NiO/YSZ composite then undergoes heat treatment in a reducing atmosphere to obtain a Ni/YSZ cermet. An anode for a SOFC is then achieved by deposition of the NiO/YSZ composite on a solid YSZ electrolyte after the calcination step described in the foregoing, followed by in situ reduction to Ni/YSZ.

It is moreover known that the performances of the nickel-cermet electrode depend on its porous structure. Open porosity of the electrode for a fuel cell is essential for transportation of reactants of the gaseous fuels to the catalytic sites and removal of the reaction products. Pore-forming agents such as balls of polymethyl methacrylate (PMMA), polyvinyl butyral (PVB), wax or saccharose are generally added to obtain the required open porosity, generally comprised between 30% and 50% by volume. Nevertheless, additional mixing and homogenization operations are then required to control the percolating porous lattice of the Ni-cermet electrode.

### OBJECT OF THE INVENTION

The object of the invention is to propose a method for fabricating a nickel-cermet electrode presenting in particular an open porosity that is simple to implement, inexpensive, and does not require the use of nickel oxide in powdery form.

According to the invention, this object is achieved by a fabrication method according to the indexed claims.

In particular, this object is achieved by a method for fabricating a nickel-cermet electrode that comprises the following successive steps:
formation at ambient temperature of a mixture comprising an organic nickel salt in solid state and at least one ceramic material in solid state,
shaping of the mixture and,
heat treatment of said shaped mixture to form the nickel-cermet electrode.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 represents the mass variation in air of a sample of tetrahydrated nickel acetate Ni(CH₃COO)₂.4H₂O versus temperature.

FIG. 2 represents a photograph seen from above of a tape of tetrahydrated nickel acetate/8% molar YSZ obtained by tapecasting.

FIG. 3 represents a scanning electron micrograph in secondary electron mode, with an enlargement ×6500, of the cermet obtained from the tape of FIG. 2.

FIG. 4 represents the mass variation in air of a sample of nickel carbonate NiCO₃ versus temperature.

FIG. 5 represents a plot of dilatometry in air of a NiCO₃-8YSZ pellet (50/50% weight) versus temperature.

FIG. 6 represents a scanning electron micrograph of the fracture surface of a Ni/8YSZ half-cell, in secondary electron mode.

### DESCRIPTION OF PARTICULAR EMBODIMENTS OF THE INVENTION

According to a particular embodiment, the method for fabricating a nickel-cermet electrode comprises a step of forming a mixture at ambient temperature comprising an organic nickel salt in solid state and at least one ceramic material in solid state, followed by shaping of the mixture. This shaping step is advantageously designed to achieve a preform to give the mixture a form close to that of the final nickel-cermet electrode. What is meant by a preform is a mixture shaped such as to present a certain cohesion and contours and/or, more generally, a form that is identical or close to that of that of the final nickel-cermet electrode. This preform is a blank of the final electrode, at a given stage of fabrication of the method where it has not yet undergone the last operation of the fabrication method. Shaping of the mixture, preferably in the form of a preform, can be performed by any known method, for example by pressing and/or moulding and/or deposition and/or tapecasting followed by cutting of the tapes. The shaped mixture, constituting the preform if this is the case, is then heat treated, preferably under reducing conditions, to form the nickel-cermet electrode. The organic nickel salt is chosen from a nickel acetate, a nickel carbonate and a nickel tartrate, in their hydrated structures or not. The organic nickel salt is advantageously a nickel carbonate.

According to a particular embodiment, the organic nickel salt is a nickel acetate. Powdery nickel acetate is mixed at ambient temperature, advantageously by mechanical stirring, with a powdery ceramic material to form a homogeneous solid mixture of Ni(CH₃COO)₂/ceramic. For example, the Ni acetate/ceramic weight ratio is chosen such that the final Ni-cermet obtained by this method contains between 20% and 70% by weight of metallic nickel. The ceramic material is advantageously chosen from a stabilized zircon in a cubic crystalline form with yttrium oxide Y₂O₃—ZrO₂ (YSZ), a partially stabilized zircon (PSZ), a scandiated and/or ceriated zircon and a substituted cerium oxide CeO₂ such as cerium gadolinium oxide (CGO). A mixture of several powdery ceramic materials can also be used to improve the performances of the electrode, for example a mixture of YSZ and CGO. The Ni(CH₃COO)₂/ceramic mixture is then shaped by any known method to form an electrode. For example, the homogeneous solid mixture can be pressed to form a preform ensuring cohesion of the homogeneous solid mixture. The preform is then heat treated by sintering, advantageously under reducing conditions, to form the nickel-cermet electrode. An electrolyte can then be deposited at the surface of the nickel-cermet electrode obtained in this way.

According to an alternative embodiment, the Ni(CH₃COO)₂/ceramic mixture can be shaped by moulding followed by pressing to form a Ni(CH₃COO)₂/ceramic preform.

According to a second embodiment, the Ni(CH₃COO)₂/ceramic mixture is formulated in the form of a viscous liquid mixture to form an ink or a paste, for example with an alcohol such as glycerol. The nickel acetate and the ceramic material(s) are then in solid state in the Ni(CH₃COO)₂/ceramic mixture. The ceramic material(s) advantageously form a sol in which the nickel acetate particles are suspended. The ink or paste is then shaped to advantageously form a preform in particular by deposition on the substrate. Conventional deposition techniques can be used, for example by screen printing, spraying, tapecasting, dip coating or spin coating.

The nickel acetate that constitutes a precursor of nickel oxide NiO is preferably in tetrahydrated crystallized form of Ni(CH₃COO)₂.4H₂O.

The substrate can advantageously be a solid electrolyte for a fuel cell, preferably a dense Y₂O₃—ZrO₂ support at 8% molar (8YSZ).

After the mixture has been formed, heat treatment of the shaped mixture is achieved, preferably under reducing conditions for example in hydrogen (H₂), to form the Ni-cermet electrode. This heat treatment ensures the cohesion of the Ni-cermet and releases an open porosity associated with departure of the oxygen atoms in gaseous form. This heat treatment is advantageously performed at temperatures comprised between 1150° C. and 1450° C., more particularly between 1200° C. and 1300° C.

According to an alternative embodiment, when heat treatment of the preform constituting the shaped mixture is performed, the nickel acetate is thermally decomposed under oxidizing conditions. This decomposition forms a solid ceramic composite of NiO/ceramic comprising nickel oxide and the ceramic material(s). The nickel oxide in the NiO/ceramic composite is trapped in the ceramic matrix and is therefore inoffensive. The nickel oxide NiO is then reduced in situ to metallic nickel Ni, in the NiO/ceramic solid ceramic composite to give a Ni-cermet electrode. In this variant, the oxidizing heat treatment can reach temperatures of 1100° C. to 1300° C., whereas the step of reducing the NiO to Ni can be performed at less high temperature. A reducing heat treatment comprised between 500° C. and 1000° C., for example 700° C., can thus be sufficient.

Thermal decomposition of Ni acetate enables creation of open pores in the proximity of the nickel catalytic sites in the Ni-cermet electrode thus obtained. For the reactants, the pores constitute access paths to the nickel catalytic sites. The electrochemical and electrocatalytic activity of the Ni-cermet electrode is all the higher the more closely the pores are bonded to the nickel particles. Access of the reactants to the catalytic sites is then fostered and the performances of the electrode are improved. The additional homogenization and mixture steps, imposed by the use of pore-forming agents, are moreover avoided.

For example, a homogeneous solid mixture of Ni(CH₃COO)₂.4H₂O/YSZ is obtained at ambient temperature from a tetrahydrated nickel acetate powder Ni(CH₃COO)₂.4H₂O and a ceramic powder at 3% molar of Y₂O₃—ZrO₂ (3YSZ) or 8% molar of Y₂O₃—ZrO₂ (8YSZ). The mixture is shaped by pressing into the form of a pellet constituting the preform. The tetrahydrated nickel acetate Ni(CH₃COO)₂.4H₂O is then decomposed by heat treatment of the preform under oxidizing conditions. Decomposition can be performed in three successive steps:
a first heat treatment is performed by a continuous progressive increase of the temperature of about 0.4° C./min, from ambient temperature to a temperature of 120° C. The temperature is then kept at 120° C. for 1 hour. This first heat treatment causes dehydration of the tetrahydrated nickel acetate Ni(CH₃COO)₂.4H₂O;
a second heat treatment is performed by a continuous progressive increase of the temperature of about 0.6° C./min, from 120° C. to 340° C., followed by a temperature plateau of 1 hour. A basic intermediate compound of nickel acetate type, 0.86Ni(CH₃COO)₂.0.14Ni(OH)₂, is then formed and is then decomposed into nickel oxide NiO with formation of open porosity;
calcination is performed by a continuous progressive increase of the temperature of about 4.8° C./min, from 340° C. to 1200° C., followed by a temperature plateau of 3 hours. This calcination ensures a good mechanical strength of the NiO/YSZ composite thus obtained.

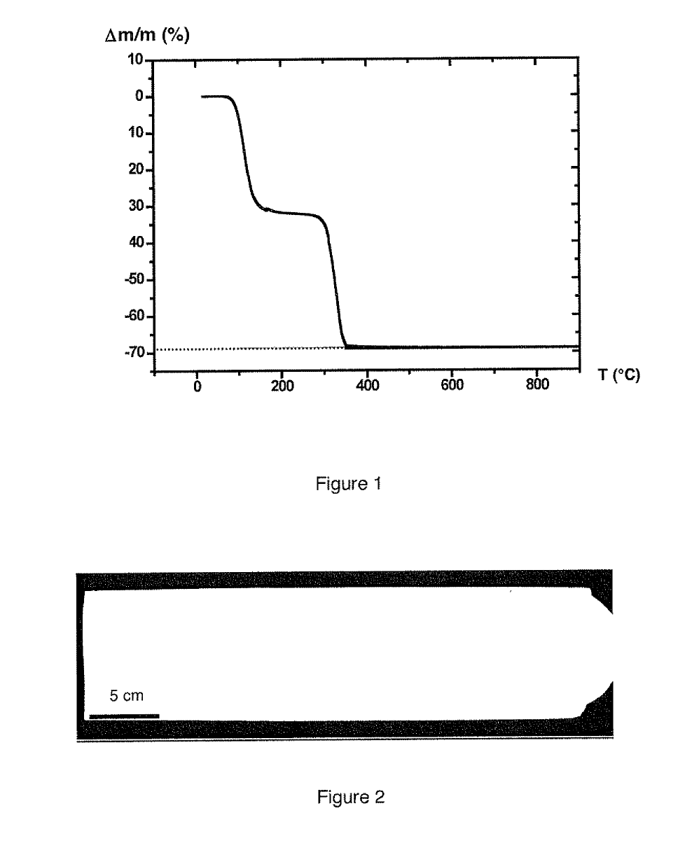

Formation of the basic intermediate nickel acetate, 0.86Ni(CH₃COO)₂.0.14Ni(OH)₂, was highlighted by thermogravimetric analysis in air of a sample of 168.55 mg of tetrahydrated nickel acetate Ni(CH₃COO)₂.4H₂O (FIG. 1). The first weight loss in fact corresponds to the release of water molecules and the second to decomposition of the basic intermediate nickel acetate, 0.86Ni(CH₃COO)₂.0.14Ni(OH)₂, into NiO. A final heat treatment in a reducing atmosphere enables the NiO/ceramic composite to be reduced to Ni/ceramic cermet and to provide an additional open porosity associated with the release of the oxygen atoms in gaseous form.

According to a second example, a tapecasting preparation with a 8YSZ and tetrahydrated nickel acetate Ni(CH₃COO)₂.4H₂O base was prepared from 40 g of powdery 8YSZ, 134 g of powdery tetrahydrated nickel acetate and 4 g of oleic acid acting as dispersant. These reactants are thoroughly mixed at ambient temperature in an azeotropic solution of solvents composed of 50 g of anhydrous ethanol and 50 g of butanone. This mixture is mechanically stirred for one hour. Two plasticizers are then added to the mixture, viz. 6 ml of benzyl butyl phtalate and 6.8 ml of polyethylene glycol with 8 g of a binder, polyvinyl butyral. This new mixture is then mechanically homogenized for 24 hours and deaerated. From this ready-to-use preparation, tapes with a thickness of a few hundred microns are cast using the tapecasting technique and then dried (FIG. 2).

These Ni(CH₃COO)₂.4H₂O/8YSZ tapes are then cut into the required shapes to form the preforms. The preforms obtained in this way by shaping of the mixture are then sintered in air with the following heat treatment:
a first heat treatment is performed by a continuous progressive increase of the temperature of about 0.4° C./min, from ambient temperature to a temperature of 120° C., followed by temperature plateau of 1 hour,
a second heat treatment is performed by a continuous progressive increase of the temperature of about 0.6° C./min, from 120° C. to 340° C., followed by temperature plateau of 1 hour,
calcination is performed by a continuous progressive increase of the temperature of about 0.4° C./min up to a first temperature plateau at 600° C. of one hour, followed by a continuous progressive increase of the temperature of about 1.7° C./min up to a second temperature plateau at 1200° C. of 3 hours and,
cooling is performed by a continuous progressive decrease of the temperature of about 5° C./min, to a temperature of 25° C.

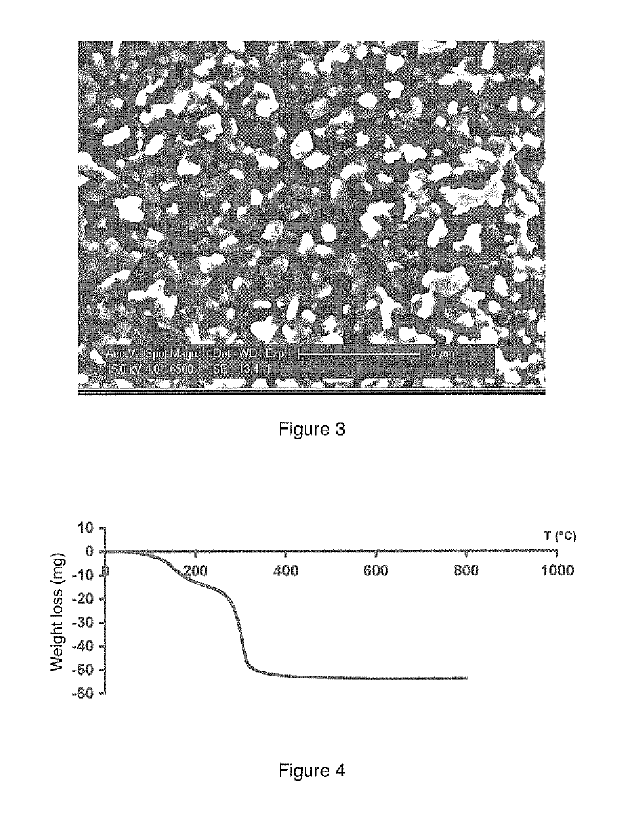

Composite substrates of NiO/8YSZ are then obtained that, after temperature reduction in a reducing atmosphere, give Ni/8YSZ cermets presenting a coherent and porous structure with an open porosity as shown in the electron micrograph in FIG. 3 made with a MEB XL30 microscope (Phillips).

According to a third particular embodiment, the organic nickel salt in solid state is a nickel carbonate NiCO₃.

Thermogravimetric analysis of a sample of 89.9 mg of nickel carbonate (FIG. 4) was performed in air. As represented in FIG. 4, a curve is obtained presenting two successive inflection points at about 100° C. and about 300° C. The first weight loss (˜100° C.) corresponds to dehydration of the nickel carbonate with release of water molecules and the second weight loss (˜300° C.) that continues up to 600° C. corresponds to total oxidation of the nickel carbonate into nickel oxide. The oxidation reaction is represented by the following formula (1):

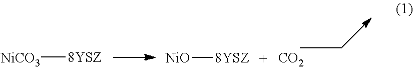

During the fabrication method of the nickel-cermet electrode, transformation of NiCO₃ into NiO can therefore take place during heat treatment, after the mixture has been shaped, without additional heat treatment being necessary.

For example, a NiCO₃/8YSZ pellet was made by mixing a NiCO₃ powder and a 8YSZ ceramic powder at ambient temperature in 50/50 weight proportions followed by shaping in the form of a pellet by pressing of the NiCO₃/8YSZ mixture. A dilatometry curve plot in air was drawn up from this pellet over temperatures ranging from ambient temperature to 1400° C.

As represented in FIG. 5, a dilatometry curve is obtained presenting two inflection points between about 100° C. and about 300° C. respectively corresponding to dehydration of the NiCO₃/8YSZ mixture followed by transformation of the nickel carbonate NiCO₃ into nickel oxide NiO, as illustrated by the thermogravimetric analysis described in the foregoing (FIG. 4). These inflection points reflect a first large compression of the sample due to a large weight loss linked to decomposition of the nickel carbonate into less voluminous nickel oxide. A third inflection point noted Pᵢ is also observed between 1100° C. and 1200° C. This third inflection point corresponds to a contraction of the sample linked to the beginning of densification of the sample. Two tangents have been drawn (FIG. 5) in order to determine this inflection point precisely, this point being situated at about 1160° C. We can deduce therefrom that by placing ourselves at 1200° C., the nickel-cermet electrode will then have sufficient cohesion while at the same time keeping an open porosity. Above 1200° C., the nickel-cermet electrode will not keep its open porosity and will lose efficiency.

For example, an electrode/electrolyte half-cell was made from two screen-printing inks. A first screen-printing ink was made from a mixture formed with 8 g of powdery NiCO₃ and 5 g of powdery 8YSZ, and 1 g of oleic acid acting as dispersant. These reactants are thoroughly mixed at ambient temperature in an azeotropic solution of solvents composed of 50 g of terpineol and 50 g of glycerol. This mixture is mechanically stirred at ambient temperature for 6 hours. A plasticizer is then added to the mixture viz. 5% weight of ethylcellulose. This new mixture is then homogenized mechanically at ambient temperature for 6 hours and deaerated for 24 hours.

A second screen-printing ink was made with pure NiCO₃. Each ink forms a viscous liquid mixture in which the 8YSZ and/or NiCO₃ particles are in solid state. The inks formed in this way are then shaped by screen-printing and heat-treated.

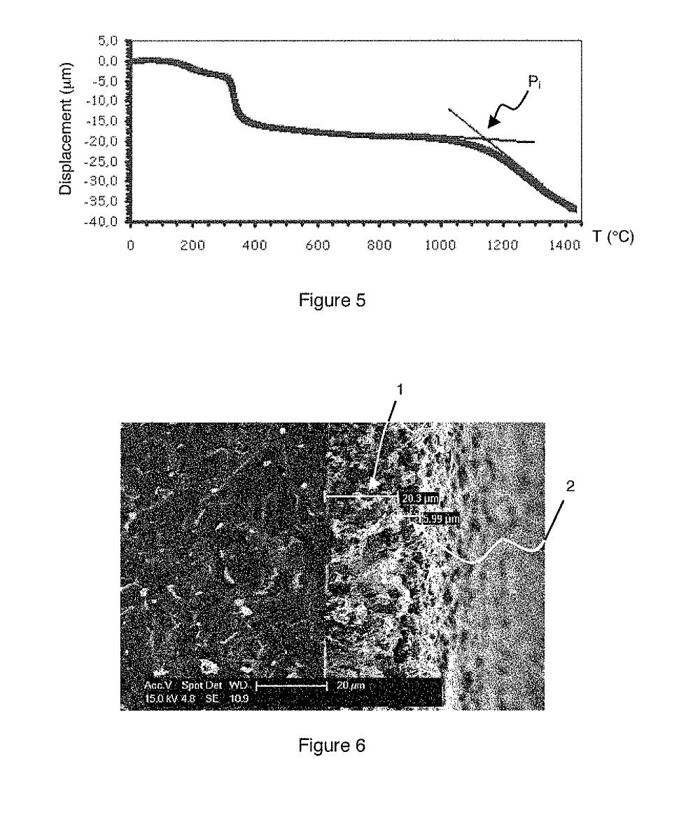

Shaping comprises three successive depositions of the first ink by screen-printing on the surface of a 8YSZ electrolyte followed by two depositions of the second ink. Between each deposition, heat treatment at 44° C. was performed to eliminate a part of the solvents used. The half-cell formed in this way is heat-treated by sintering in air for 3 hours at 1200° C. to form the NiO/8YSZ bulk composite and is then reduced for 3 hours at 800° C. under a flux of an argon/H₂ (2%) mixture in order to form the Ni/8YSZ porous bulk cermet. The three screen-printing depositions of the first ink (initial NiCO₃/8YSZ mixture) constitutes the Ni/8YSZ functional layer of the electrode/electrolyte half-cell and the two screen-printing depositions of the second ink (NiCO₃) constitute the Ni collector layer. The fracture surface of the electrode/electrolyte half-cell thus prepared is observed under a Scanning Electron Microscope (SEM) in secondary electron mode (FIG. 6).

In this micrograph represented in FIG. 6, functional layer 1 and collector layer 2 are clearly visible and respectively measure about 20 μm and about 6 μm. The micrograph shows a very good cohesion between the cermet electrode and electrolyte and a characteristic open porosity at the electrode/electrolyte interface.

The fabrication method according to the present invention is particularly advantageous for fabrication of nickel-cermet electrodes for SOFC fuel cells requiring a good porosity. It involves commonplace operations that are simple and easy to implement, without using toxic initial reactants such as nickel oxide in powder form. The costly handling precautions imposed by the use of NiO in powder form are consequently avoided.

1-14. (canceled)

15. A method for fabricating a nickel-cermet electrode comprising the following successive steps:
formation at ambient temperature of a mixture comprising an organic nickel salt in solid state and at least one ceramic material in solid state,
shaping of said mixture and,
heat treatment of said shaped mixture to form the nickel-cermet electrode.

16. The method for fabricating according to claim 15, wherein heat treatment is performed under reducing conditions.

17. The method for fabricating according to claim 15, comprising the following successive steps:
formation at ambient temperature of a mixture comprising an organic nickel salt in solid state and at least one ceramic material in solid state,
shaping of the mixture and,
heat treatment of said shaped mixture, under oxidizing conditions, to form a solid ceramic composite comprising nickel oxide and the ceramic material and,
reduction, in the solid ceramic composite, of nickel oxide into metallic nickel.

18. The method for fabricating according to claim 15, wherein the organic nickel salt is chosen from a nickel acetate, a nickel carbonate and a nickel tartrate.

19. The method for fabricating according to claim 15, wherein the mixture is a homogeneous solid mixture obtained by mixing powdery organic nickel salt and powdery ceramic material.

20. The method for fabricating according to claim 15, wherein the mixture is a viscous liquid mixture forming an ink or a paste.

21. The method for fabricating according to claim 15, wherein shaping of the mixture comprises deposition of said mixture on a substrate.

22. The method for fabricating according to claim 21, wherein the substrate is a solid electrolyte.

23. The method for fabricating according to claim 15, wherein the ceramic material is chosen from a zircon stabilized in cubic crystalline form with yttrium oxide Y2O3—ZrO2, a partially stabilized zircon, a scandiated and/or ceriated zircon and a substituted cerium oxide CeO2.

24. The method for fabricating according to claim 15, wherein the organic nickel salt is nickel acetate in tetrahydrated crystallized form Ni(CH₃COO)₂.4H₂O.

25. The method for fabricating according to claim 24, wherein heat treatment is performed in the following successive steps:
a first heat treatment up to 120° C.,
a second heat treatment up to 340° C.,
calcination up to 1200° C.

26. The method for fabricating according to claim 25, wherein:
the first heat treatment is performed by continuous progressive increase of the temperature, from ambient temperature to a temperature of 120° C., followed by a temperature plateau of 1 hour,
the second heat treatment is performed by continuous progressive increase of the temperature, from 120° C. to 340° C., followed by a temperature plateau of 1 hour,
calcination is performed by continuous progressive increase of the temperature, from 340° C. to 1200° C., followed by a temperature plateau of 3 hours.

27. The method for fabricating according to claim 25, wherein:
the first heat treatment is performed by continuous progressive increase of the temperature, from ambient temperature to a temperature of 120° C., followed by a temperature plateau of 1 hour,
the second heat treatment is performed by continuous progressive increase of the temperature, from 120° C. to 340° C., followed by a temperature plateau of 1 hour,
calcination is performed by continuous progressive increase of the temperature up to a first temperature plateau at 600° C. of 1 hour followed by a continuous progressive increase of the temperature up to a second temperature plateau at 1200° C. of 3 hours.

28. The method for fabricating according to claim 15, wherein the mixture is a Ni(CH₃COO)₂.4H₂O/YSZ mixture.

29. The method for fabricating according to claim 28, wherein heat treatment is performed in the following successive steps:
a first heat treatment up to 120° C.,
a second heat treatment up to 340° C.,
calcination up to 1200° C.

30. The method for fabricating according to claim 29, wherein:
the first heat treatment is performed by continuous progressive increase of the temperature, from ambient temperature to a temperature of 120° C., followed by a temperature plateau of 1 hour,
the second heat treatment is performed by continuous progressive increase of the temperature, from 120° C. to 340° C., followed by a temperature plateau of 1 hour,
calcination is performed by continuous progressive increase of the temperature, from 340° C. to 1200° C., followed by a temperature plateau of 3 hours.

31. The method for fabricating according to claim 29, wherein:
the first heat treatment is performed by continuous progressive increase of the temperature, from ambient temperature to a temperature of 120° C., followed by a temperature plateau of 1 hour,
the second heat treatment is performed by continuous progressive increase of the temperature, from 120° C. to 340° C., followed by a temperature plateau of 1 hour,
calcination is performed by continuous progressive increase of the temperature up to a first temperature plateau at 600° C. of 1 hour followed by a continuous progressive increase of the temperature up to a second temperature plateau at 1200° C. of 3 hours.
